(19) United States
(12) Patent Application Publication
(10) Pub. No.: US 2016/0282707 A1
(43) Pub. Date: Sep. 29, 2016

(54) PROJECTION CONTROL APPARATUS AND CONTROL METHOD

(71) Applicant: CANON KABUSHIKI KAISHA, Tokyo (JP)

(72) Inventor: Eisaku Tatsumi, Kawasaki-shi (JP)

(21) Appl. No.: 15/072,701

(22) Filed: Mar. 17, 2016

(30) Foreign Application Priority Data
Mar. 23, 2015 (JP) 2015-060020

(51) Int. Cl. G03B 21/20; G03B 21/00

(52) U.S. Cl. CPC G03B 21/2053; G03B 21/006; G03B 21/204

(57) ABSTRACT

Provided is a technology that favorably represents tones. The illumination amount of light from a light source with which a light modulator is illuminated is controlled, according to tone values of pixels to be represented with the light modulator.

### BACKGROUND OF THE INVENTION

1. Field of the Invention

The present invention relates to an image projection technology.

2. Description of the Related Art

In conventional color projectors, generally light that has been spatially modulated for each of RGB light components using three LCDs is projected after being optically composited. Generally, the three LCDs represent tones using analog modulation which involves changing the voltage applied to each pixel.

Japanese Patent Laid-Open No. 11-65477 discloses a configuration for displaying color images by focusing light of the three colors RGB onto a single analog liquid crystal display while switching between the RGB light.

In the case of using a digital mirror device (hereinafter, DMD) as a spatial modulation element instead of a liquid crystal displays (hereinafter, LCD), tones are represented using digital modulation that utilizes the high-speed ON/OFF characteristics of DMDs. Representation of color images is performed by combining one DMD with a color wheel and temporally compositing a plurality of subfields for each of the colors RGB, utilizing the high-speed ON/OFF characteristics. Also, instead of a color wheel, light sources of the three primary colors can be realized by using LEDs of the three primary colors as light sources, or using a laser and a phosphor wheel.

Furthermore, projectors that provide tones through LCDs performing digital modulation that uses subfields in a similar manner to DMDs are becoming commercially available in some areas.

Also, Japanese Patent Laid-Open No. 2011-203292 discloses an example in which tones are produced depending on the number of subfields, using solid-state light sources of three colors and a single digitally driven liquid crystal panel. In this example, power consumption is reduced by turning the solid-state light sources ON/OFF to coincide with the ON/OFF of the digital drive. Also, in this example, tones are produced using a plurality of fixed period subfields, with a large number of subfields being needed to enhance the number of tones.

However, even though it is necessary, in the case of using an LCD or a reflective liquid crystal (herein after LCOS (Liquid Crystal On Silicon)) in analog modulation, to switch the tone level of respective pixels for each color, the tone level of respective pixels of a liquid crystal display cannot be switched at high speed, due to the physical properties of liquid crystal displays. Thus, the tone value of one color affects the tone value of the next color, and the image may look as if the colors have been mixed.

Also, in the case of digitally driving a LCD or a LCOS is a similar manner to a DMD and representing tones with temporal tones, the digital modulation LCD switches at a higher voltage than analog modulation, enabling ON/OFF to be switched at a reasonably high speed. However, an LCD is not physically capable of ultra high-speed modulation similar to a DMD, even when digitally driven. Also, even if the LCD is a ferroelectric liquid crystal display, ON/OFF switching takes longer than with a DMD. Thus, with an LCD, the ON transition time and the OFF transition time affect the tone of each subfield, with the tones differing between when subfields are ON continuously and ON discontinuously. As a result, it may not be possible to represent correct tone values due to the integrated tone values obtained by combining temporal tones not being exact.

### SUMMARY OF THE INVENTION

According to one embodiment of the present invention, a projection technology that is able to favorably represent tones is provided.

According to one aspect of the present invention, there is provided a projection control apparatus that projects light from a light source after having modulated the light with a light modulator, comprising: a determination unit configured to determine tone values of pixels to be represented by the light modulator; and a control unit configured to control an illumination amount of light from the light source with which the light modulator is illuminated, according to the tone values of pixels to be represented by the light modulator.

Also, according to another aspect of the present invention, there is provided a method of controlling a projection control apparatus that projects light from a light source after having modulated the light with a light modulator, the method comprising: determining tone values of pixels to be represented by the light modulator; and controlling an illumination amount of light from the light source with which the light modulator is illuminated, according to the tone values of pixels to be represented by the light modulator.

Furthermore, according to another aspect of the present invention, there is provided a non-transitory computer readable storage medium storing a program for causing a computer of a projection control apparatus that projects light from a light source after having modulated the light with a light modulator to execute: determining tone values of pixels to be represented by the light modulator; and controlling an illumination amount of light from the light source with which the light modulator is illuminated, according to tone values of pixels to be represented by the light modulator.

Further features of the present invention will become apparent from the following description of exemplary embodiments with reference to the attached drawings.

### BRIEF DESCRIPTION OF THE DRAWINGS

FIGS. 1A to 1C are diagrams comparing the relationship between subfields and light sources with conventional examples.

FIG. 2 is a block diagram of constituent elements of a projection control apparatus of a first embodiment.

FIG. 3 is a schematic diagram of constituent elements of the projection control apparatus of the first embodiment.

FIG. 4 is a diagram illustrating the circumstances under which light is controlled in the first embodiment.

FIG. 5 is a flowchart showing timing control in the first embodiment.

FIG. 6 is a table showing the relationship between subfields and tones in the first embodiment.

FIG. 7 is a block diagram of constituent elements of a projection control apparatus of a second embodiment.

FIG. 8 is a schematic diagram of constituent elements of the projection control apparatus of the second embodiment.

FIG. 9 is a diagram illustrating the circumstances under which light is controlled in the second embodiment.

FIG. 10 is a schematic diagram of constituent elements of a projection control apparatus of a third embodiment.

FIG. 11 is a diagram illustrating the circumstances under which light is controlled in the third embodiment.

FIG. 12 is a schematic diagram of constituent elements of a projection control apparatus of a fourth embodiment.

FIG. 13 is a diagram illustrating the circumstances under which light is controlled in the fourth embodiment.

### DESCRIPTION OF THE EMBODIMENTS

Hereinafter, embodiments of the present invention will be described in detail using the drawings.

Outline

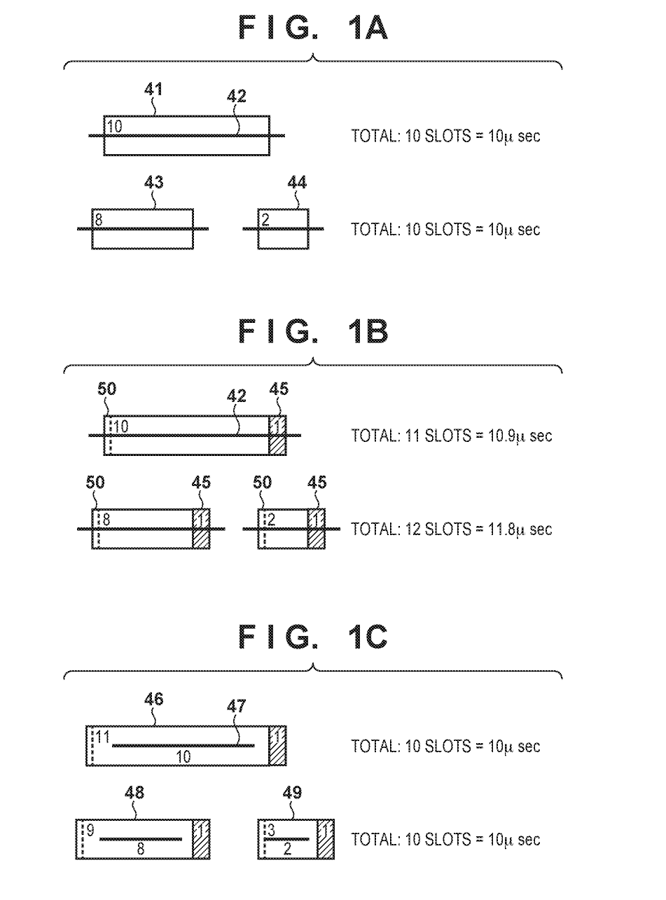

The features of a tone representation method according to the embodiments will be described using the relationship between the number of slots for each subfield and light source control shown in FIGS. 1A to 1C. Here, FIG. 1A is a diagram showing the relationship between subfields and light source control in a conventional DMD. FIG. 1B is a diagram showing the relationship between subfields and light source control in a conventional LCD. FIG. 1C is a diagram showing the relationship between subfields and light source control in a LCD of the embodiments.

In these diagrams, reference numeral 41 denotes a 10-slot subfield. Reference numeral 42 denotes light source emission. Reference numeral 43 denotes an 8-slot subfield. Reference numeral 44 denotes a 2-slot subfield. Reference numeral 45 denotes an OFF transition state of an LCD. Reference numeral 46 denotes an 11-slot subfield. Reference numeral 47 denotes a temporally controlled light source. Reference numeral 48 denotes a 9-slot subfield. Reference numeral 49 denotes a 3-slot subfield. Reference numeral 50 denotes an ON transition state of an LCD.

In the embodiments, one unit in which respective pixels are turned ON/OFF within a subfield is used as a slot, and the ON or OFF time period of pixels is defined by the number of slots.

Here, description will be given, with the time period of 1 slot given as a time unit of 1 μsec as an example. In this case, the time period of the 10-slot subfield 41 when the DMD of FIG. 1A is ON (reflecting on the projection side) will be 10 μsec. The light source emission 42 at this time is emitted for the same as or longer than the duration of the subfield. Therefore, 10 μsec of display tones are realized.

Similarly, with the 8-slot subfield 43 and the 2-slot subfield 44, the light source emission 42 is emitted for the same as or longer than the duration of the subfield, and thus 8 μsec and 2 μsec of display tones, respectively, are realized. Note that the sum total of display tones for 8 slots and 2 slots matches the display tones for 10 slots. Therefore, because the display tones are the same whether the subfields are continuous or discontinuous, tones are correctly represented.

FIG. 1B shows an ON transition time and an OFF transition time as transition times of an LCD. Because the ON transition time is comparatively short at about 200 nsec, and the amount of light passed during ON transition gradually increases, the light amount during the ON transition time will, on average, be approximately half of the amount of light that is passed. FIG. 1B shows the case where a light amount equivalent to 0.1 slots is lost on average during the ON transition time. On the other hand, because the OFF transition time is comparatively as long at about 2 μsec and the amount of light passed during the OFF transition time gradually decreases, the light amount during the OFF transition time will, on average, be approximately half of the amount of light that is passed. Therefore, FIG. 1B shows the case where a light amount equivalent to 1 slot is passed on average during the OFF transition time.

The LCD passes the light source emission 42 for a time period that is shorter by the time period of the ON transition state 50 and longer by the time period of the OFF transition state 45, when the 10-slot subfield 41 is turned on. Because the amount of light passed during transition states changes, the light amount during the ON and OFF transition times will, on average, be approximately half of the amount of light that is passed. This light amount is, in the ON transition state 50, equivalent to 0.1 slots which is half of 0.2 slots, and is, in the OFF transition state 45, equivalent to 1 slot which is half of 2 slots.

As a result, display tones equivalent to a light amount of 10.9 μsec, which is equivalent to 10.9 slots, are realized in total.

Similarly, with the 8-slot subfield 43 and the 2-slot subfield 44, the amount of light passed in the ON transition state 50 is subtracted and the amount of light passed in the OFF transition state 45 is added. Thus, in the 8-slot subfield 43 and the 2-slot subfield 44, display tones equivalent to light amounts of 8.9 μsec and 2.9 μsec, respectively, are realized. As a result, the sum total of the display tones for 8 slots and 2 slots will be 11.8 μsec, which is 0.9 μsec longer than the display tones for 10 slots. As such, because the total number of slots and the display tones in the case where the ON subfields are continuous and in the case where the ON subfields are discontinuous do not match, tones cannot be displayed as envisioned, and a malady known as tone level difference occurs in the image.

FIG. 1C similarly shows an ON transition time and an OFF transition time as transition times of an LCD, and envisions the case where a light amount equivalent to 1 slot is passed on average during the OFF transition time. In FIG. 1C, the number of slots of the LCD that are ON is increased compared with FIG. 1B to respectively give the 11-slot subfield 46, the 9-slot subfield 48, and the 3-slot subfield 49.

Here, the lighting period 47 of the light source is shorter than the ON period of the LCD, and is a light emission time corresponding to the number of slots to be displayed. Light emission for 10 slots is performed during the subfield 46. 10 μsec of display tones are realized by such control, regardless of the OFF transition state 45 of the LCD. Similarly, if light source emission for 8 slots in the 9-slot subfield 48 and for 2 slots in the 3-slot subfield 49 is performed, a total of 10 slots=10 μsec of display tones are realized, which matches the display tones in the case of one 11-slot subfield 46.

One feature of the embodiments is the realization of display tones that are not affected by the transition time of a liquid crystal display, by controlling the amount of light emission of the light source so as to match the display tones, rather than matching the ON period of the liquid crystal panel that is used as a light modulator for modulating light from the light source to the display tones.

### First Embodiment

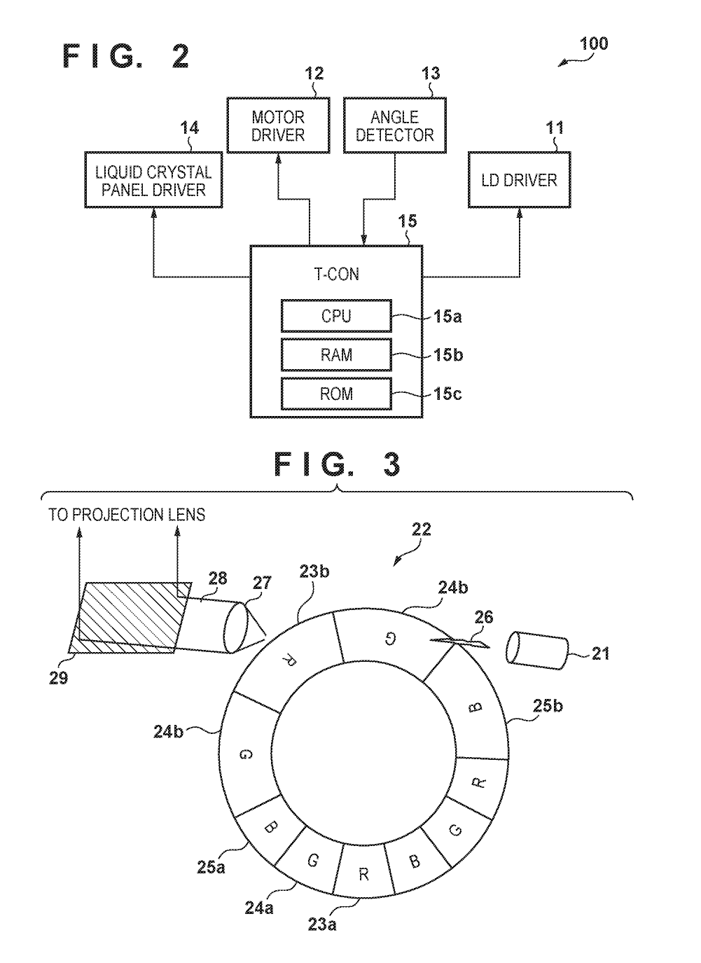

FIG. 2 is a block diagram of constituent elements of a projection control apparatus of the first embodiment.

In a projection control apparatus 100, reference numeral 11 denotes a LD driver that turns on a laser diode (LD). Reference numeral 12 denotes a motor driver of a wheel motor that turns a phosphor wheel 22 (FIG. 3). Reference numeral 13 denotes an angle detector for detecting the rotation position (rotation angle) of the phosphor wheel 22. Reference numeral 14 denotes a liquid crystal panel driver that drives a LCOS panel 29 (FIG. 3). Reference numeral 15 denotes a timing controller (T-CON) that synchronizes and controls the timing of the drivers, namely, the LD driver 11, the motor driver 12, and the liquid crystal panel driver 14. A CPU 15a, a RAM 15b, and a ROM 15c are built into the timing controller 15. The timing controller 15 controls the operations of the constituent elements of the projection control apparatus 100 as a result of the CPU 15a reading out programs that are stored in the ROM 15c and executing the read programs on the RAM 15b.

FIG. 3 is a schematic diagram of constituent elements of the projection control apparatus of the first embodiment.

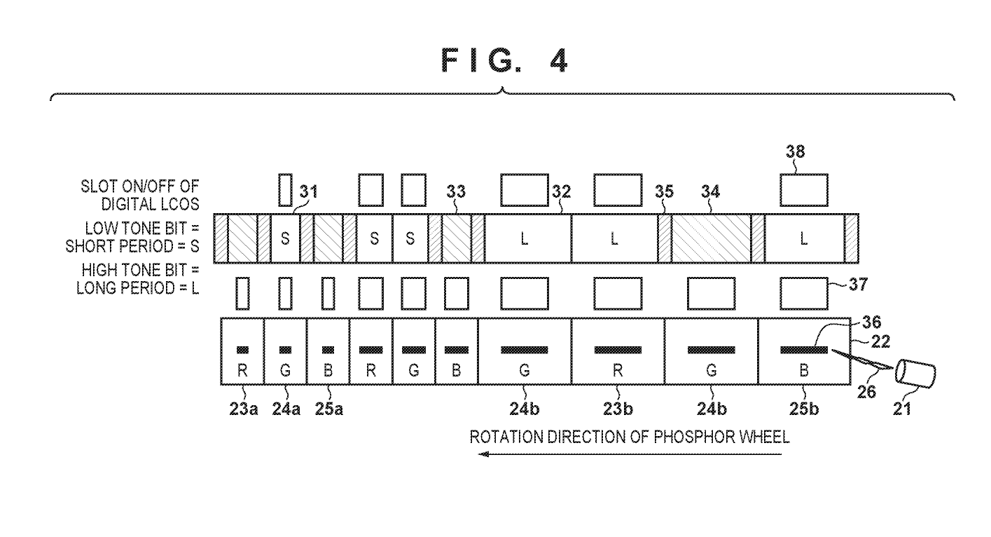

Reference numeral 21 denotes an ultraviolet or blue laser diode. Reference numeral 22 denotes the phosphor wheel. Reference numeral 23 denotes red phosphor that emits red (R) light. Reference numeral 24 denotes green phosphor that emits green (G) light. Reference numeral 25 denotes a blue phosphor that emits blue (B) light. In FIG. 3, the red phosphor 23a, the green phosphor 24a and the blue phosphor 25a correspond to short-period slots. The red phosphor 23b, the green phosphor 24b and the blue phosphor 25b correspond to long-period slots. The short-period slots and the long-period slots will be described with reference to FIG. 4 later. Reference numeral 26 denotes output light of the laser diode 21. Reference numeral 27 denotes an optical lens that converts the light emission of each color phosphor into parallel light. Reference numeral 28 denotes parallel light from the optical lens 27. Reference numeral 29 denotes the LCOS panel which is a digitally driven reflective LCD.

Note that the laser diode 21 is a high efficiency light source that may also be referred to as a semiconductor laser, and, in the present embodiment, a laser diode that emits ultraviolet light or blue light is used. A green light source and a red light source are realized by respectively illuminating the green phosphor 24 and the red phosphor 23 with light from the laser diode 21, and a blue light source is realized by illuminating the blue phosphor 25 with ultraviolet light. The blue light source may, however, be realized by disposing obscured glass rather than the blue phosphor 25, and illuminating the obscured glass with blue light.

Hereinafter, operations of the projection control apparatus 100 of the first embodiment will be described.

The timing controller 15 rotates the phosphor wheel 22 at a constant speed by driving a wheel motor (not shown) using the motor driver 12. Also, the timing controller 15 performs, on the LCOS panel 29, ON/OFF control of the respective pixels for each subfield within the image frame to be displayed, using the liquid crystal panel driver 14.

Here, the rotation speed of the phosphor wheel 22 is a constant multiple of the frame frequency at which display is performed on the LCOS panel 29. A speed of 1× is described as an example, but speeds of 2×, ½× and the like are possible. Because the total number of color phosphors (red phosphor 23, green phosphor 24, blue phosphor 25) constituting the phosphor wheel 22 equals the number of subfields, the red phosphor 23, the green phosphor 24, the blue phosphor 25 are respectively disposed in seven places, nine places and seven places, for example. In the diagram, illustration of the number of places where phosphors are disposed has been simplified. Note that because a large amount of green component is needed in order to produce white, a configuration can be adopted in which more green phosphor 24 is disposed than the other colors.

Also, the timing controller 15 calculates the type and position (illumination position) of phosphor on the phosphor wheel 22 that is to be illuminated with the light of the laser diode 21, using the angle detector 13 that detects the rotation position (rotation angle) of the phosphor wheel 22. The timing controller 15 determines and controls the timing at which the laser diode 21 is driven, based on the calculation result. The timing controller 15 then drives the laser diode 21 using the LD driver 11, so as to illuminate the calculated illumination position with the output light 26 of the laser diode 21.

Because the phosphors emit light of their respective colors in point emission form when struck with the output light 26 of the laser diode 21, this point emission is converted into the parallel light 28 using the optical lens 27 and strikes the LCOS panel 29.

In the LCOS panel 29, light is reflected by portions where pixels are ON and absorbed when pixels are OFF, and thus reflected light is projected onto a projection plane (e.g., screen, etc.) using a projection lens (not shown) as a subfield image. A plurality of subfield images are temporally composited in the viewing environment of the viewer and recognized as frame images, by being continuously projected.

Control of the light of this projection control apparatus 100 shown in FIG. 3 will be described using FIG. 4. FIG. 4 is a diagram illustrating the circumstances under which light is controlled in the projection control apparatus of the first embodiment. Note that, in FIG. 4, constituent elements that are in common with FIG. 3 will be described with the same reference numerals attached.

In FIG. 4, reference numeral 31 denotes short-period ON slots of pixels on the LCOS panel 29. Reference numeral 32 denotes long-period ON slots of pixels on the LCOS panel 29. Reference numeral 33 denotes short-period OFF slots of pixels on the LCOS panel 29. Reference numeral 34 denotes long-period OFF slots of pixels on the LCOS panel 29. Reference numeral 35 denotes the transition state of pixels on the LCOS panel 29. Reference numeral 36 denotes the light emission width of phosphors. Reference numeral 37 denotes the light emission of phosphors. Reference numeral 38 denotes reflected light of the LCOS panel 29.

Here, the short-period ON slot 31 is the duration for which the slot is turned ON for shorter than a predetermined period. In contrast, the long-period ON slot 32 is the duration for which the slot is turned ON for longer than the predetermined period. Similarly, the short-period OFF slot 33 is the duration for which the slot is turned OFF for shorter than a predetermined period. In contrast, the long-period OFF slot 34 is the duration for which the slot is turned OFF for longer than the predetermined period.

The color phosphors are assumed to have at least two widths that are shorter or longer than a predetermined length. The color phosphors (red phosphor 23, green phosphor 24, blue phosphor 25) pass in front of the laser diode 21 with the rotation of the phosphor wheel 22. The laser diode 21 controls the light emission time according to the tone number (tone value) for each subfield. In the example given in the diagram, light emission times are extended so as to achieve a ratio of 1:2:4. Note that this light emission time is controlled on the basis of information on the phosphor wheel 22 from the angle detector 13 so as to use only a central part of the phosphors (i.e., portion corresponding to a time period except for the transition time in which pixels are in a transition state). This results in the light emission 37 from the color phosphors being obtained.

Each pixel of the LCOS panel 29 is turned ON and OFF for a number of slots that differs for each subfield. In FIG. 3 and FIG. 4, the case where there are two types of slots, namely, short-period slots (short-period ON slots 31 or short-period OFF slots 33) and long-period slots (long-period ON slots 32 or long-period OFF slots 34), is illustrated. However, the slots are not limited to two types, and there may be three or more types.

The reflected light 38 is obtained when the light emission 37 from the color phosphors strikes the pixels on the LCOS panel 29 at the time of the short-period ON slot 31 or the long-period ON slot 32. On the other hand, the reflected light 38 is not be obtained when the light emission 37 from the color phosphors strikes the pixels on the LCOS panel 29 at the time of the short-period OFF slot 33 or the long-period OFF slot 34.

Because pixels enter the transition state 35 when a slot transitions from ON to OFF or from OFF to ON, reflected light will not be satisfactorily obtained at this time. In view of this, the ON/OFF timing of the LD driver 11 is controlled by the timing controller 15, so as to be synchronized with switching of the color phosphors of the phosphor wheel 22. The output light 26 of the laser diode 21 is thereby controlled so as to strike a central part of the color phosphors, and so that the light emission 37 of phosphors does not strike pixels on the LCOS panel 29 at the time of the transition state 35.

In the present embodiment, because ON/OFF control of the light source is performed in a short time period so as to prevent light emission from the phosphors from striking pixels in the transition state, a problem arises if the excitation period of the phosphors is long. Because the excitation period of the phosphors is from 10 ns to 10 μsec depending on the type of phosphor, phosphors with a short excitation period are used in the present embodiment. In other words, phosphors whose excitation period is sufficiently short at no more than several fractions of the transition state period of the liquid crystal display are used. Note that the ON transition time and the OFF transition time of a laser diode is so short compared with the transition state period of a liquid crystal display that it can generally be disregarded, and thus need not be taken into consideration.

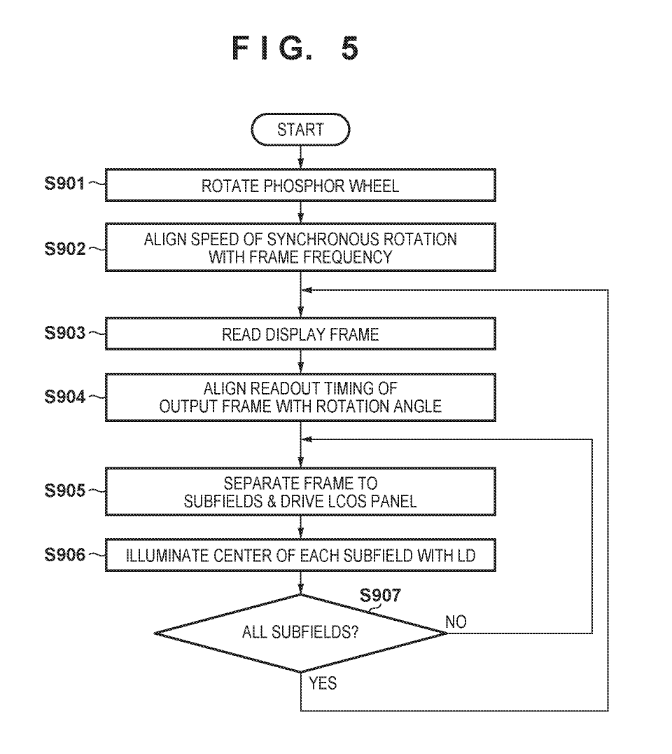

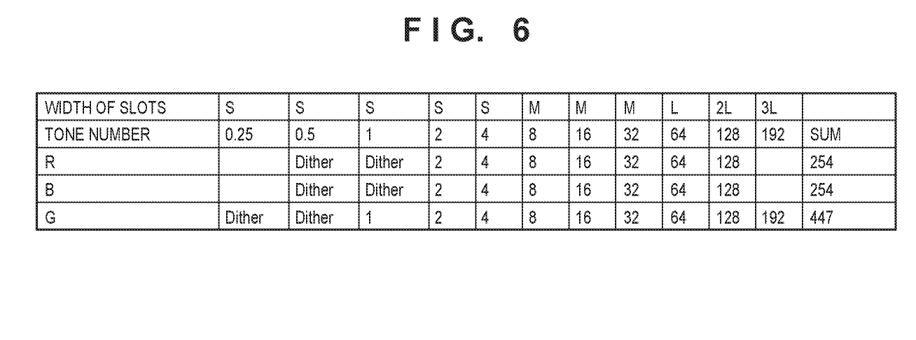

Next, the processing that is executed by the projection control apparatus 100 will be described using the flowchart of FIG. 5.

FIG. 5 is a flowchart showing timing control that is executed by the projection control apparatus of the first embodiment. When a projection apparatus that regulates the projection control apparatus is powered on, and an image to be displayed (image to be projected) is input from an information processing apparatus (e.g., personal computer) that is connected to the projection apparatus, the timing controller 15 starts processing based on the input image. Note that this processing is realized by the CPU 15a of the timing controller 15 reading out a program that is stored in the ROM 15c and executing the read program on the RAM 15b.

In step S901, the timing controller 15 starts rotation of the phosphor wheel 22 using the motor driver 12. When the rotation speed has increased, the timing controller 15, in step S902, synchronizes the rotation speed of the phosphor wheel 22 with a constant multiple of the frame frequency of the input image. This constant multiple is determined by the relationship between the number of subfields of the LCOS panel 29 and the number of color phosphors. If the number of subfields and the number of phosphors are the same, the rotation speed (number of rotations) of the phosphor wheel 22 when the frame frequency is 59.94 Hz, for example, will be 3596.4 rpm. Because the number of rotations can be halved if the number of phosphors is double the number of subfields, the rotation speed (number of rotations) of the phosphor wheel 22 in this case will be 1798.2 rpm.

In step S903, the timing controller 15 reads the frame (display frame) of the input image that is to be initially displayed to a buffer memory secured in the RAM 15c. In step S904, the timing controller 15 aligns the timing at which readout of the output frame is started with the signal from the angle detector 13. In step S905, the timing controller 15 reads out the output frame as subfields for each tone (i.e., separates the output frame to subfields), and digitally drives the LCOS panel 29 using the LCD driver 14. In step S906, the timing controller 15 causes the laser diode to emit light using the LD driver 11 and illuminate the phosphors, centering on a temporally central part of each subfield. In step S907, the timing controller 15 determines whether all of the subfields have been displayed. If all of the subfields have not displayed (NO in step S907), the timing controller 15 repeats the processing of steps S905 and S906 until all of the subfields are displayed. When all of the subfields have been displayed (YES in step S907), the timing controller 15 returns to step S903 and executes the processing of the next display frame to be processed.

FIG. 6 is a table representing the relationship between subfields and tones in the first embodiment.

The first line of the table is width of slots equivalent to the ON period of a digitally driven LCOS per subfield. Note that, a width of slots can be presented also by the number of slots as shown in FIGS. 1A to 1C. Accordingly, the first line of the table in FIG. 6 may be the number of slots instead of the width of slots. The second line is the tone number for each subfield, which is proportional to the light emission time of the laser diode 21. The third line shows the allocation of subfields to the red phosphor 23 (R). The fourth line shows the allocation of subfields to the blue phosphor 25 (B). The fifth line shows the allocation of subfields to the green phosphor 24 (G).

Also, the first column of the table shows titles. The second to 12th columns of the table show the tone number for each subfield. The 13th column of the table shows the total value (SUM) of the tone numbers.

In this table, the time period per slot is given as 1 μsec, and the light emission time equivalent to 1 tone is also given as 1 μsec.

S slots indicating slots that are shorter than a predetermined length are given as 6 slots=6 μsec, which is longer than the light emission time of the highest tone number 4. M slots indicating slots that are about the same as the predetermined length are given as 34 slots=34 μsec, which is longer than the light emission time of the highest tone number 32. L slots indicating slots that are longer than the predetermined length are given as 66 slots=66 μsec, which is longer than light emission time of the tone number 64. 2L slots indicating slots that are twice as long as the L slots are given as 130 slots=130 μsec, which is longer than light emission time of the tone number 128. 3L slots indicating slots that are three times as long as the length of L slots are given as 194 slots=194 μsec, which is longer than light emission time of the tone number 192.

Seven subfields consisting of two S slot, three M slots, one L slot and one 2L slot are used for the red phosphor 23 and the blue phosphor 25. Nine subfields consisting of additional one more S slot and one 3L slot are used for the green phosphor 24. The number of subfields for the color phosphors totals 23 subfields for the three colors.

The total period of the subfields is: S slots*7+M slot*9+L slots*3+2L slots*3+3L slots*1=6*7+34*9+66*3+130*3+194*1=1130 μsec. This total period is within the 1 frame period of 1666 μsec at 60 frames per second.

Furthermore, in order to represent tones under the respective lowest tones, the number of tones is increased by two, using temporal dithering between frames or spatial dithering of adjacent pixels.

This enables red and blue to represent 9 tones and green to represent 10.5 tones, and thus enough tones to project a normal image are secured. Furthermore, the green component required for white can be projected approximately 1.7 times stronger compared with the other colors, enabling bright white to be projected.

As described above, according to the first embodiment, display tones can be represented without being affected by the transition time of the liquid crystal display, by controlling the light emission time of the light source to match the display tones, rather than matching the ON time of the LCD to the display tones.

In other words, it becomes possible to represent exact tones even when using a digitally driven liquid crystal panel. Because tone representation is possible with a single digitally driven liquid crystal panel, and LCD is generally cheaper than DLP (Digital Light Processing) and easily increased in resolution, a high-resolution projection apparatus that is compact and low cost can thereby be realized.

### Second Embodiment

The second embodiment describes a configuration that uses LEDs of three colors instead of the laser diode 21 and the phosphor wheel 22 of the first embodiment.

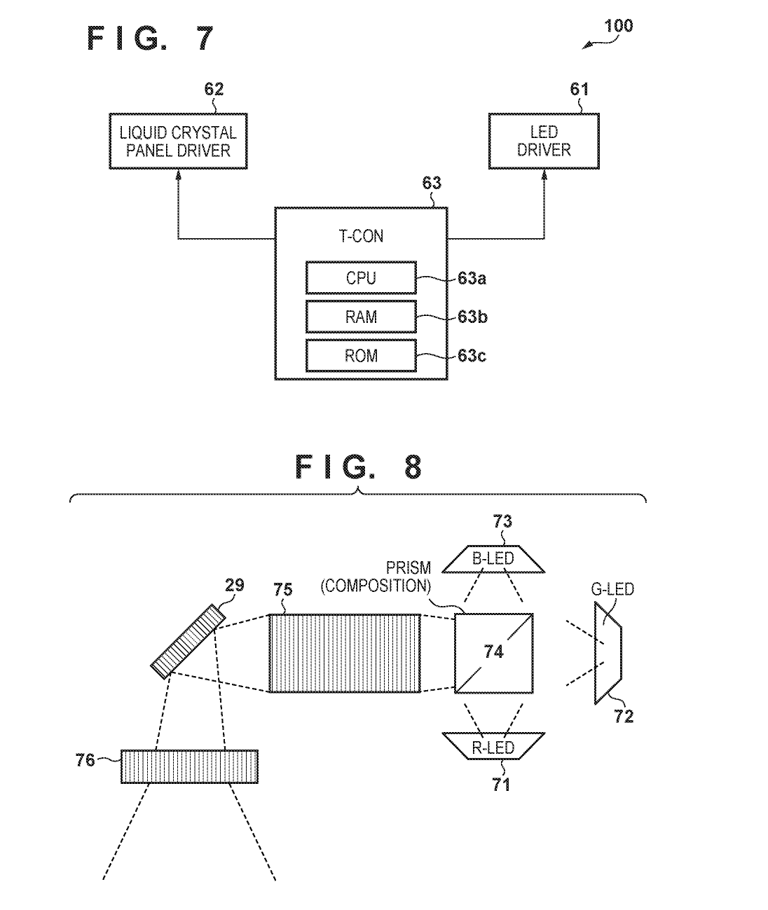

FIG. 7 is a block diagram of constituent elements of a projection control apparatus of the second embodiment.

Reference numeral 61 denotes an LED driver that turns on the LEDs. Reference numeral 62 denotes a liquid crystal panel driver that drives the LCOS panel 29 (FIG. 8). Reference numeral 63 denotes a timing controller (T-CON) that synchronizes and controls the timing of the LED driver 61 and the liquid crystal panel driver 62. A CPU 63a, a RAM 63b, and a ROM 63c are built into the timing controller 63. The timing controller 63 controls the operations of the constituent elements of the projection control apparatus 100, as a result of the CPU 63a reading out programs stored in the ROM 63c and executing the read program on the RAM 63b.

FIG. 8 is a schematic diagram of constituent elements of the projection control apparatus of the second embodiment.

Reference numeral 29 denotes a LCOS panel which is a digitally driven reflective LCD. Reference numeral 71 denotes a red LED (R-LED). Reference numeral 72 denotes a green LED (G-LED). Reference numeral 73 denotes a blue LED (B-LED). Reference numeral 74 denotes a composition prism. Reference numeral 75 denotes a focus correction optical system. Reference numeral 76 denotes a projection lens.

The timing controller 63 digitally drives a single LCOS panel 29 using the liquid crystal panel driver 62. Also, the timing controller 63 controls the light emission time and light emission intensity in lighting the red LED 71, the green LED 72 and the blue LED 73, using the LED driver 61. The light emission intensity is controlled by changing the drive current of the LED driver 61.

When any one of the color LEDs is turned on, the direction of light therefrom is changed by the composition prism 74, and the light is converted into parallel light by the focus correction optical system 75 and illuminated onto the LCOS panel 29. Because the pixels of the LCOS panel 29 are turned ON or OFF for each of the respective subfields, only the light reflected by the ON pixels passes through the projection lens 76 and is projected onto a screen (not shown).

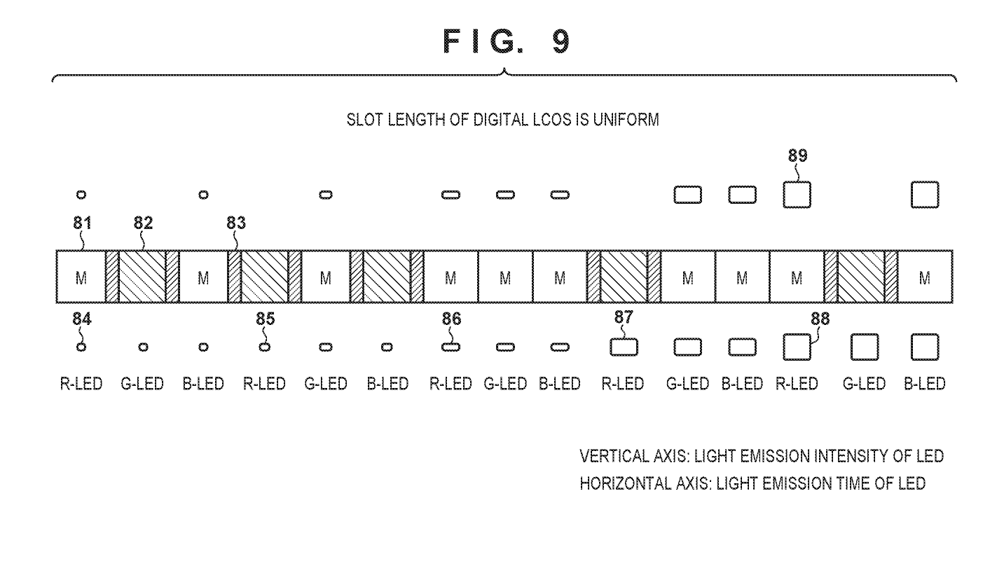

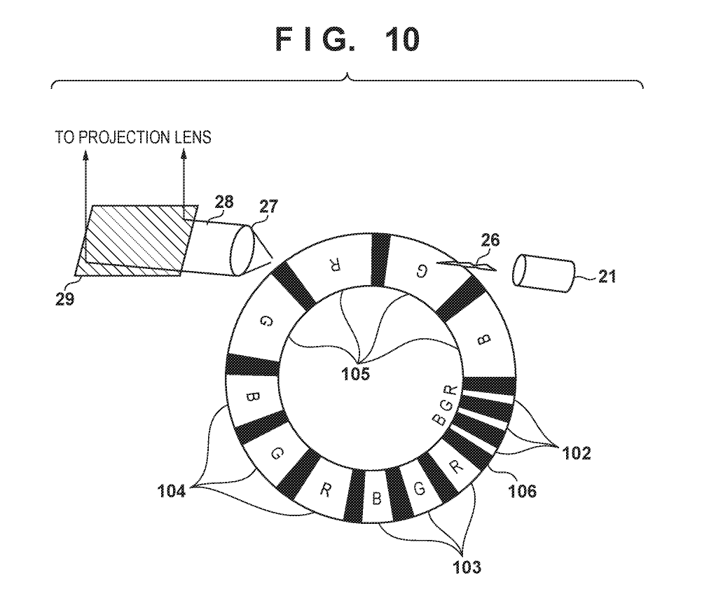

The control timing of the subfields of the LCOS panel 29 and the lighting of the three color LEDs at this time will be described using FIG. 9. FIG. 9 is a diagram illustrating the circumstances under which light is controlled in the projection control apparatus of the second embodiment. Note that, in FIG. 9, constituent elements that are in common with FIG. 8 will be described with the same reference numerals.

In FIG. 9, reference numeral 81 denotes intermediate-period ON slots of pixels on the LCOS panel 29. Reference numeral 82 denotes intermediate-period OFF slots of pixels on the LCOS panel 29. Reference numeral 83 denotes the transition state of pixels on the LCOS panel 29. Reference numeral 84 denotes a pulsed light emission from the color LEDs that is shorter than a first predetermined length and weaker than a first predetermined intensity. Reference numeral 85 denotes a pulsed light emission from the color LEDs that is longer than the first predetermined length and weaker than the first predetermined intensity. Reference numeral 86 denotes a pulsed light emission from the color LEDs that is longer than a second predetermined length and weaker than the first predetermined intensity. Reference numeral 87 denotes a pulsed light emission from the color LEDs that is longer than the second predetermined length and stronger than the first predetermined intensity. Reference numeral 88 denotes a pulsed light emission from the color LEDs that is stronger than the second predetermined intensity and longer than the second predetermined length. Reference numeral 89 denotes reflected light of the LCOS panel 29.

Here, the intermediate-period ON slot 81 is the duration for which the slot is turned ON for an intermediate period (e.g., predetermined period) having a length between the short-period ON slot 31 and the long-period ON slot 32 of the first embodiment. Similarly, the intermediate-period OFF slot 82 is the duration for which the slot is turned OFF for an intermediate period (e.g., predetermined period) having a length between the short-period OFF slot 33 and the long-period OFF slot 34 of the first embodiment.

Furthermore, the second predetermined length is longer than the first predetermined length. Also, the second predetermined intensity is stronger than the first predetermined intensity. In other words, the pulsed light emissions 84 to 88 increase in at least one of length and intensity in the stated order.

The timing controller 63 controls the light emission time and light emission intensity of the three color LEDs (red LED 71, green LED 72, blue LED 73) according to the tone number for each subfield. In the example in the diagram, the ratio of light emission times is given in the order 1, 2, 4, 4 and 4, and the ratio of emission intensities is given in the order 1, 1, 1, 1, 2 and 4. Then, because the tone is the product of the light emission time and the light emission intensity, the ratio of tones will be 1, 2, 4, 8 and 16, enabling 2⁵ tones to be represented. By increasing either the types of light emission times or the types of emission intensities in this way, it is possible to easily represent from 2⁸ tones to 2¹⁰ tones necessary in representing an image.

The timing controller 63 selects the intermediate-period ON slot 81, which is an ON state, or the intermediate-period OFF slot 82, which is an OFF state, for respective pixels of each subfield of the LCOS panel 29. The timing controller 63, however, controls the emission timing such that the transition state 83 does not overlap with the pulsed light emissions 84 to 88 of the different colors. This enables reflected light that is not satisfactory obtained in the transition state 83 of the LCOS panel 29 to be excepted, and makes it possible to represent the correct tone number.

As described above, according to the second embodiment, because the light emission intensity of an LED can be more easily controlled than a laser diode, a high tone number can be easily created by controlling both the light emission time and the light emission intensity.

Therefore, although it is also possible to constitute a plurality of slot widths of the LCOS panel, as described in the second embodiment, timing control can be facilitated by making the slot widths of the LCOS panel uniform.

Note that because the distribution of subfields to each color for representing the tone number conforms to the first embodiment, description is omitted here. Also, although the second embodiment is described using a configuration that uses LEDs of three colors, the present invention is not limited to that number of LEDs (light emitting diodes) or to LEDs as long as a solid-state light source that is able to output three or more types of light of different wavelengths is used.

### Third Embodiment

The third embodiment describes a configuration that performs tone control of the light emission time using a black mask on the phosphor wheel of the first embodiment. Note that because the block diagram of the constituent elements of the projection control apparatus 100 of the third embodiment is the same as the block diagram of the constituent elements of the projection control apparatus of the first embodiment shown in FIG. 2, description thereof will be omitted.

FIG. 10 is a schematic diagram of the constituent elements of the projection control apparatus of the third embodiment. Note that, in FIG. 10, constituent elements that are in common with FIG. 3 of the first embodiment will be described with the same reference numerals attached.

Reference numeral 101 denotes a phosphor wheel for controlling light emission time. Reference numeral 102 denotes color phosphors whose opening is narrower than a first predetermined length. Reference numeral 103 denotes color phosphors whose opening is wider than the first predetermined length. Reference numeral 104 denotes color phosphors whose opening is narrower than a second predetermined length. Reference numeral 105 denotes color phosphors whose opening is wider than the second predetermined length. The first predetermined length is shorter than the second predetermined length. The size relationship among the openings satisfies, the opening of color phosphors 102<the opening of color phosphors 103<the opening of color phosphors 104<the opening of color phosphors 105. Reference numeral 106 denotes a black mask that masks the area between the color phosphors.

Note that, in FIG. 10, in order to simplify the diagram, the number of types of widths of the opening of the color phosphors is given as four types, although, in practice, it is possible to have up to eight types of widths. Also, the second predetermined length is longer than the first predetermined length. Obscured glass of various colors can also be used instead of color phosphors. In any case, the present invention is not limited to phosphors or obscured glass, as long as a light source that is able to emit light of the required colors is used as the light source.

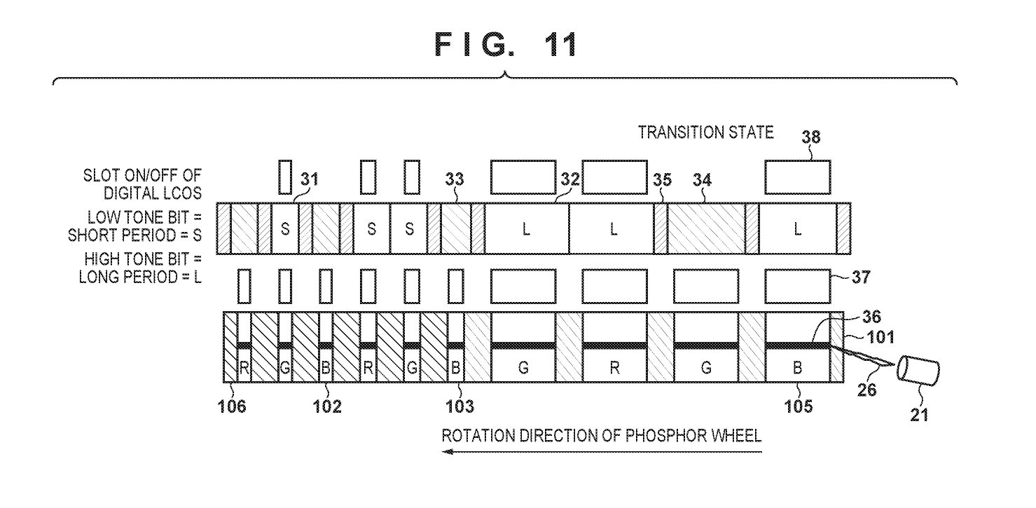

In the present embodiment, instead of determining tones using the light emission time of the laser diode 21, tones are determined by adjusting the width of the opening that exposes the phosphors using the black mask 106 that shields light. Controlling light using color phosphors 102 to 105, the black mask 106, and the slot of the LCOS panel 29 will be described using FIG. 11.

FIG. 11 is a diagram illustrating the circumstances under which light is controlled in the projection control apparatus of the third embodiment. Note that, in FIG. 11, constituent elements that are in common with FIG. 4 or 10 will be described with the same reference numerals attached. Also, in FIG. 11, color phosphors 104 are omitted in order to simplify the diagram.

The color phosphors 102, 103, 104 and 105 and the black mask 106 pass in front of the laser diode 21 with the rotation of a phosphor wheel 101. This results in the light emission 37, which is a time period that depends on the width of the opening of the color phosphors 102 to 105, being obtained. Here, this light emission 37 is obtained by the timing controller 15 of FIGS. 1A to 1C controls the angle of the phosphor wheel 101 and the ON/OFF timing of the pixels of the LCOS panel 29, so as to avoid the transition state 35 of the pixels of the LCOS panel 29. In other words, control is performed such that the black mask 106 passes in front of the phosphor wheel 101 at the timing at which light strikes in the transition state 35.

With such a configuration, the light emission 37 is only reflected by the LCOS panel 29 at portions of subfields (short-period ON slots 31) where the pixels of the LCOS panel 29 are ON, enabling the reflected light 38 to be obtained.

Because pixels will be in the transition state 35 when a slot transitions from ON to OFF or from OFF to ON, reflected light is not satisfactorily obtained at that time. Here, a feature of the present embodiment is the restriction provided by the black mask 106 so as to prevent the phosphors from emitting light (i.e., prohibiting the light emission of phosphors) in sections corresponding to the transition state 35 (during the transition time). Hence, the laser diode 21 does not need to finely control emission to avoid the transition state 35, and the length of the excitation period of phosphors is not particularly restricted. Although, in the first embodiment, the excitation period needs to be sufficiently shorter than the transition state period of a liquid crystal display, in the present embodiment, the excitation period can be the same as or shorter than the transition state period of a liquid crystal display.

Note that although, in the present embodiment, tones are represented with time widths equivalent to the angles at which the phosphors are open, tones may be represented by emission intensities by using phosphors whose emission intensities differ for each subfield.

As described above, according to the third embodiment, the operations of the laser diode 21 can be simplified and the overall control load can be reduced, in addition to the effects described in the first embodiment. In the first and third embodiments, it is also possible to perform a greater luminous flux projection by providing a yellow phosphor or a white phosphor in a portion of the wide slot for a green phosphor.

### Fourth Embodiment

The fourth embodiment describes a configuration that uses three digitally driven liquid crystal panels. Note that the block diagram of constituent elements of a projection control apparatus 100 in the fourth embodiment is basically the same as the block diagram of constituent elements of the second embodiment shown in FIG. 7, although the liquid crystal panel driver 62 in the fourth embodiment differs from the third embodiment in that it drives three liquid crystal panels (LCOS panels).

FIG. 12 is a schematic diagram of constituent elements of the projection control apparatus of the fourth embodiment. Note that, in FIG. 11, constituent elements that are in common with FIG. 8 of the second embodiment will be described with the same reference numerals attached.

Reference numeral 121 denotes a LCOS panel for R pixels. Reference numeral 122 denotes a LCOS panel for G pixels. Reference numeral 123 denotes a LCOS panel for B pixels.

The timing controller 63 digitally drives the three LCOS panels 121, 122 and 123 using the liquid crystal panel driver 62. Also, the timing controller 63 controls the light emission time and light emission intensity in lighting of the red LED 71, the green LED 72 and the blue LED 73, using the LED driver 61. Light emission intensity is controlled by changing the drive current of the LED driver 61.

With the three LCOS panels 121 to 123, light emission of the LEDs only passes through the pixels of each LCOS panel that are ON. The direction of this light is changed by the composition prism 74, and the light is converted to parallel light by the focus correction optical system 75, and then passes through the projection lens 76 and is projected onto a screen (not shown).

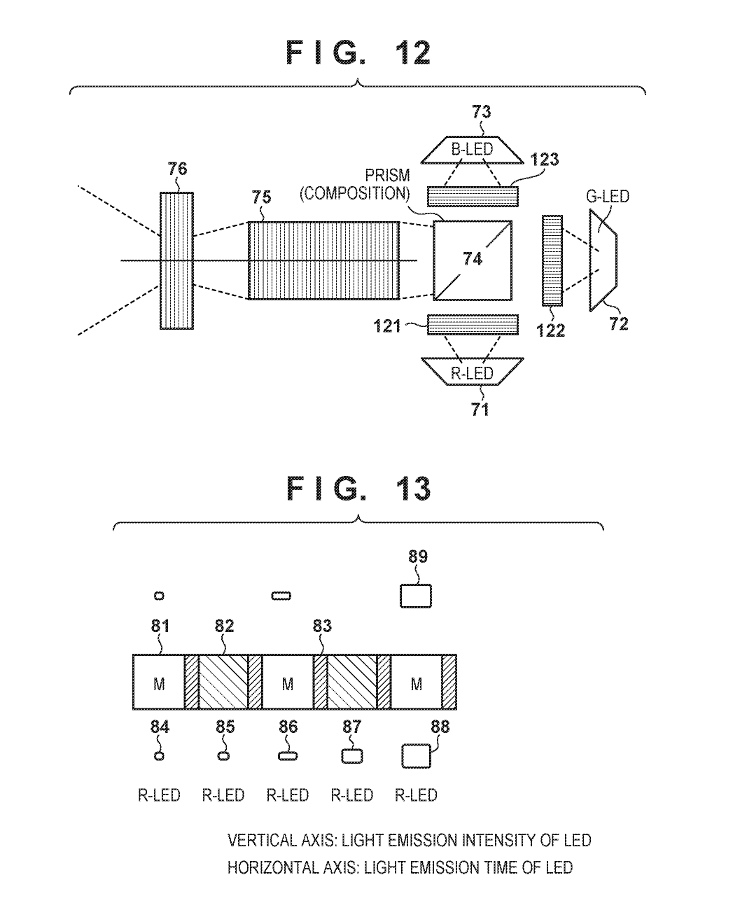

The control timing of the subfields of the three LCOS panels 121 to 123 and the lighting of the three color LEDs at this time will be described using FIG. 13. FIG. 13 is a diagram illustrating the circumstances under which light is controlled in the projection control apparatus of the fourth embodiment. Note that FIG. 13 shows a configuration obtained by extracting a portion of the contents of FIG. 9 in the second embodiment. Specifically, FIG. 13 shows the configuration for the red LED 71 and the LCOS panel 121 for R pixels of FIG. 9. Here, the configurations for green and blue are similar to red, and have thus been omitted.

In FIG. 13, the timing controller 63 controls the light emission time and the light emission intensity (of the red LED 71, the green LED 72 and the blue LED 73) according to the tone number for each subfield. This control is similar to the control illustrated with FIG. 9 of the second embodiment. In FIG. 13, the timing controller 63 selects the intermediate-period ON slot 81, which is an ON state, or the intermediate-period OFF slot 82, which is an OFF state, for respective pixels of each subfield of the LCOS panel 121 for R pixels. The timing controller 63, however, controls the emission timing such that the transition state 83 does not overlap with the pulsed light emissions 84 to 88 of the different colors. This enables reflected light that is not satisfactory obtained in the transition state 83 of the LCOS panel 121 for R pixels to be excepted, and makes it possible to represent the correct tone number.

By performing similar control for the green LED 72 and the LCOS panel 122 for G pixels and for the blue LED 73 and the LCOS panel 123 for B pixels, the correct tone number for these colors can also be represented.

As described above, according to the fourth embodiment, subfields of the different colors can be simultaneously disposed by using three LCD panels, enabling projected light that is brighter than one LCD panel to be obtained, in addition to the effects described in the second embodiment.

### Fifth Embodiment

It is also possible to realize an embodiment that suitably combines the first to fourth embodiments according to the application and purpose.

Also, a feature that is common to each embodiment is controlling an amount of light (hereinafter, referred to as illumination amount) with which a liquid crystal panel, which is a light modulator, is illuminated with light from a light source, according to tones that are represented with the light modulator. Specifically, in the first embodiment, this control involves controlling the illumination amount with which a liquid crystal panel is illuminated with light from a light source, by controlling the light amount (light emission time) from the light source. In the second and fourth embodiments, this control involves controlling the illumination amount with which a liquid crystal panel is illuminated with light from a light source, by controlling light amount (light emission time and light emission intensity) from the light source. Furthermore, in the third embodiment, this control involves controlling the illumination amount with which a liquid crystal panel is illuminated with light from a light source, by restricting light from the light source with a black mask provided on the phosphors.

In any case, the present invention is not limited to the configurations described in the first to fourth embodiments, as long as it is possible to control the illumination amount of light from a light source with which a light modulator is illuminated, according to tones represented with the light modulator.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-060020, filed Mar. 23, 2015, which is hereby incorporated by reference herein in its entirety.

What is claimed is:

1. A projection control apparatus that projects light from a light source after having modulated the light with a light modulator, comprising:
a determination unit configured to determine tone values of pixels to be represented by the light modulator; and
a control unit configured to control an illumination amount of light from the light source with which the light modulator is illuminated, according to the tone values of pixels to be represented by the light modulator.

2. The apparatus according to claim 1, wherein the control unit controls the illumination amount of light from the light source with which the light modulator is illuminated, by controlling a light emission time of light from the light source with which the light modulator is illuminated, according to the tone values of pixels to be represented with the light modulator.

3. The apparatus according to claim 2, wherein the control unit controls the light emission time, with a time period that excepts a transition time in which pixels of the light modulator transition between ON and OFF.

4. The apparatus according to claim 1, wherein the control unit controls the illumination amount of light from the light source with which the light modulator is illuminated, by controlling at least one of a light emission time and a light emission intensity of light from the light source with which the light modulator is illuminated, according to the tone values of pixels to be represented with the light modulator.

5. The apparatus according to claim 1, wherein the control unit controls the illumination amount of light from the light source with which the light modulator is illuminated, by restricting light from the light source with which the light modulator is illuminated, according to the tone values of pixels to be represented with the light modulator.

6. The apparatus according to claim 5, wherein the control unit restricts light from the light source with which the light modulator is illuminated, during a transition time in which pixels of the light modulator transition between ON and OFF.

7. The apparatus according to claim 1, wherein the light source is a solid-state light source that outputs light of three or more different wavelengths.

8. The apparatus according to claim 7, wherein the solid-state light source is constituted by combining a laser diode and a phosphor wheel.

9. The apparatus according to claim 7, wherein the solid-state light source consists of light emitting diodes that output light of three or more different wavelengths.

10. The apparatus according to claim 1, wherein the light modulator is one or three liquid crystal panels.

11. A method of controlling a projection control apparatus that projects light from a light source after having modulated the light with a light modulator, the method comprising:
determining tone values of pixels to be represented by the light modulator; and
controlling an illumination amount of light from the light source with which the light modulator is illuminated, according to the tone values of pixels to be represented by the light modulator.

12. A non-transitory computer readable storage medium storing a program for causing a computer of a projection control apparatus that projects light from a light source after having modulated the light with a light modulator to execute:
determining tone values of pixels to be represented by the light modulator; and
controlling an illumination amount of light from the light source with which the light modulator is illuminated, according to tone values of pixels to be represented by the light modulator.
